(19) United States
(12) Patent Application Publication
(10) Pub. No.: US 2018/0219847 A1
(43) Pub. Date: Aug. 2, 2018

(54) MESSAGING APPLICATION HOSTING FOR MESSAGE CAPTURE

(71) Applicant: Actiance, Inc., Redwood City, CA (US)

(72) Inventors: Jae Kim, Castro Valley, CA (US); Jayachandran Balachandran, San Mateo, CA (US)

(73) Assignee: Actiance, Inc., Redwood City, CA (US)

(21) Appl. No.: 15/886,799

(22) Filed: Feb. 1, 2018

Related U.S. Application Data
(60) Provisional application No. 62/453,955, filed on Feb. 2, 2017.

(51) Int. Cl. H04L 29/06; H04L 12/58; H04W 12/06

(52) U.S. Cl. CPC H04L 63/08; H04L 63/126; H04W 12/06; H04L 51/04

(57) ABSTRACT

Provided are methods, systems, and computer-program products for hosting a messaging application remote from a user to facilitate tracking messages sent to or received by a messaging application linked to the hosted messaging application. In some embodiments, hosting the messaging application remote from the user may require that a remote system obtain one or more authentication credentials so that the remote system may authenticate the hosted messaging application with a messaging application system. In such embodiments, the one or more authentication credentials may include data for directly authenticating with the messaging application system (e.g., a username and/or password for an account) or data for indirectly authenticating with the messaging application system (e.g., token, such as a quick response (QR) code), or the like.

### CROSS-REFERENCES TO RELATED APPLICATIONS

This application claims priority to U.S. Provisional Patent Application No. 62/453,955 filed on Feb. 2, 2017, entitled “Browser Messaging Application Hosting,” the disclosure of which is hereby incorporated by reference in its entirety for all purposes.

### BACKGROUND

Messaging applications, such as BlackBerry® Messenger™, Facebook™ Messenger, Google Hangouts™, KakaoTalk®, LINE (Line Corporation, Japan), WeChat®, and WhatsApp®, may be used to communicate over the Internet or other type of network. However, such messaging applications may include security mechanisms that may make it difficult for enterprises to monitor communications. For example, some messaging applications may include encryption on communications to prevent interception of the communications. Therefore, there is a need in the art to allow enterprises to capture communications sent and received using messaging applications.

### SUMMARY

The present disclosure relates generally to techniques for tracking messages sent to or received by a messaging application, and more particularly to hosting a messaging application remote from a user to facilitate tracking messages sent to or received by a messaging application linked to the hosted messaging application.

In some embodiments, hosting the messaging application remote from the user may require that a remote system obtain one or more authentication credentials so that the remote system may authenticate the hosted messaging application with a messaging application system. In such embodiments, the one or more authentication credentials may include data for directly authenticating with the messaging application system (e.g., a username and/or password for an account) or data for indirectly authenticating with the messaging application system (e.g., token, such as a quick response (QR) code), or the like.

When directly authenticating with a messaging application system, a remote system may begin by sending a request for one or more authentication credentials to a user device (e.g., a first device). The first device may then respond with the one or more authentication credentials.

Using the one or more authentication credentials, the remote system may cause a messaging application hosted by the remote system to authenticate itself for an account with the messaging application system (sometimes referred to as logging into the account). For example, the remote system may supply a username and password to the messaging application system. In response to receiving the one or more authentication credentials, the messaging application system may authenticate the hosted messaging application for the account.

After verifying an authenticated session between the hosted messaging application and the messaging application system, the remote system may allow the first device (or another device related to the user) to use (or continue to use) a messaging application thereon.

When indirectly authenticating with a messaging application system, a remote system may provide a first device temporary permission to use a messaging application. The first device may then authenticate a messaging application with the messaging application system.

After the first device has authenticated the messaging application for the account, the remote system may request to link a messaging application hosted by the remote system with the messaging application of the first device for the account. In response to the request, the messaging application system may send a token (e.g., a quick response (QR) code) to the remote system. The token may be used to pass information from the messaging application system to multiple devices before being received at the messaging application system. The circular process may be used to authenticate the hosted messaging application using the authentication of the first device.

Because the remote system may not have a display component and/or the remote system may not be in proximity to the first device, the remote system may send the token to a second device. The second device may present the token so that the first device (while having a messaging application authenticated with the messaging application system for the account) may receive the token (e.g., scan or input). In response to receiving the token, the first device may send the token to the messaging application system, completing authentication of the messaging application of the remote system. After verifying an authenticated session between the remote system and the messaging application system, the remote system may allow the first device to use (or continue to use) a messaging application thereon.

In such examples as described above, the messaging application of the remote system and the messaging application of the first device may both be authenticated for the same account such that messages sent and received by one of the messaging applications are sent to the other messaging application.

In some embodiments, the messaging application of the remote system may be executing based upon a modified library file. The modified library file may cause the messaging application of the remote system to send communications to a message capture subsystem of the remote system when the messaging application of the remote system sends or receives messages using the messaging application of the remote system.

Numerous benefits are achieved by way of the present disclosure over conventional techniques. For example, embodiments of the present disclosure provide access by a remote system to messages as they are being displayed to a user. The embodiments also provide a method to send and receive messages programmatically, allowing developers to develop messaging bots. Using programmatic message sending, disclaimer messages can be sent automatically to remind the messaging participants of the fact that the messages are being monitored at the beginning of conversation. Embodiments of the present disclosure also provide a way to receive messages and programmatically respond to the incoming messages depending on the messaging command. Embodiments of the present disclosure also allow a way for an enterprise to monitor messages sent and received by an employee of the enterprise without having a device of the employee to stay connected to a monitoring system. These and other embodiments of the present disclosure, along with many of its advantages and features, are described in more detail in conjunction with the text below and attached figures.

### BRIEF DESCRIPTION OF THE DRAWINGS

Illustrative embodiments are described in detail below with reference to the following figures:

FIGS. 1A-1D illustrate an example for configuring a distributed system for message capture using a first type of authentication according to certain embodiments described herein;

FIGS. 2A-2B illustrate an example for configuring a distributed system for message capture using a second type of authentication according to certain embodiments described herein;

FIG. 3 illustrates an example of communication of a message in a distributed system according to certain embodiments described herein;

FIG. 4 is a simplified flowchart depicting processing performed for configuring a messaging application of a remote system to send messages to a message capture subsystem of the remote system according to certain embodiments described herein; and

FIG. 5 illustrates an example of a computer system according to certain embodiments described herein.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Messaging applications, such as BlackBerry® Messenger™, Facebook™ Messenger, Google Hangouts™, KakaoTalk®, LINE (Line Corporation, Japan), WeChat®, and WhatsApp®, can be used to communicate over the Internet or other type of network. However, such messaging applications can include security mechanisms that may make it difficult for enterprises to monitor communications. For example, some messaging applications may include encryption on communications to prevent interception of the communications.

The present disclosure relates generally to techniques for tracking messages sent to or received by a messaging application, and more particularly to hosting a messaging application remote from a user to facilitate tracking messages sent to or received by a messaging application linked to the hosted messaging application.

In some embodiments, hosting the messaging application remote from the user may require that a remote system obtain one or more authentication credentials so that the remote system may authenticate the hosted messaging application with a messaging application system. In such embodiments, the one or more authentication credentials may include data for directly authenticating with the messaging application system (e.g., a username and/or password for an account) or data for indirectly authenticating with the messaging application system (e.g., token, such as a quick response (QR) code), or the like.

When directly authenticating with a messaging application system, a remote system may begin by sending a request for one or more authentication credentials to a user device (e.g., a first device). The first device may then respond with the one or more authentication credentials.

Using the one or more authentication credentials, the remote system may cause a messaging application hosted by the remote system to authenticate itself for an account with the messaging application system (sometimes referred to as logging into the account). For example, the remote system may supply a username and password to the messaging application system. In response to receiving the one or more authentication credentials, the messaging application system may authenticate the hosted messaging application for the account.

After verifying an authenticated session between the hosted messaging application and the messaging application system, the remote system may allow the first device (or another device related to the user) to use (or continue to use) a messaging application thereon.

When indirectly authenticating with a messaging application system, a remote system may provide a first device temporary permission to use a messaging application. The first device may then authenticate a messaging application with the messaging application system.

After the first device has authenticated the messaging application for the account, the remote system may request to link a messaging application hosted by the remote system with the messaging application of the first device for the account. In response to the request, the messaging application system may send a token (e.g., a quick response (QR) code) to the remote system. The token may be used to pass information from the messaging application system to multiple devices before being received at the messaging application system. The circular process may be used to authenticate the hosted messaging application using the authentication of the first device.

Because the remote system may not have a display component and/or the remote system may not be in proximity to the first device, the remote system may send the token to a second device. The second device may present the token so that the first device (while having a messaging application authenticated with the messaging application system for the account) may receive the token (e.g., scan or input). In response to receiving the token, the first device may send the token to the messaging application system, completing authentication of the messaging application of the remote system. After verifying an authenticated session between the remote system and the messaging application system, the remote system may allow the first device to use (or continue to use) a messaging application thereon.

In such examples as described above, the messaging application of the remote system and the messaging application of the first device may both be authenticated for the same account such that messages sent and received by one of the messaging applications are sent to the other messaging application.

In some embodiments, the messaging application of the remote system may be executing based upon a modified library file. The modified library file may cause the messaging application of the remote system to send communications to a message capture subsystem of the remote system when the messaging application of the remote system sends or receives messages using the messaging application of the remote system.

While some disclosure herein describes a messaging application included in a remote system, it should be recognized that the messaging application might not be included in a remote system, but rather remote from the remote system as described in U.S. Provisional Patent Application No. 62/446,110 filed on Jan. 13, 2017, entitled “Message Capture For Cross-Platform Messaging System” and U.S. Non-Provisional patent application Ser. No. 15/870,791 filed on Jan. 17, 2018, entitled “Message Capture for Messaging System,” the disclosures of which are hereby incorporated by reference in their entirety for all purposes. The messaging application might also be remote from both a device associated with a user and the remote system. Such solutions, where the messaging application is remote from a user device (either on the remote system or a separate device), may allow a user to not have to maintain an active connection between one of their devices and the remote system. Instead, a messaging application (linked to a messaging application on a user device) may be maintained by the remote system.

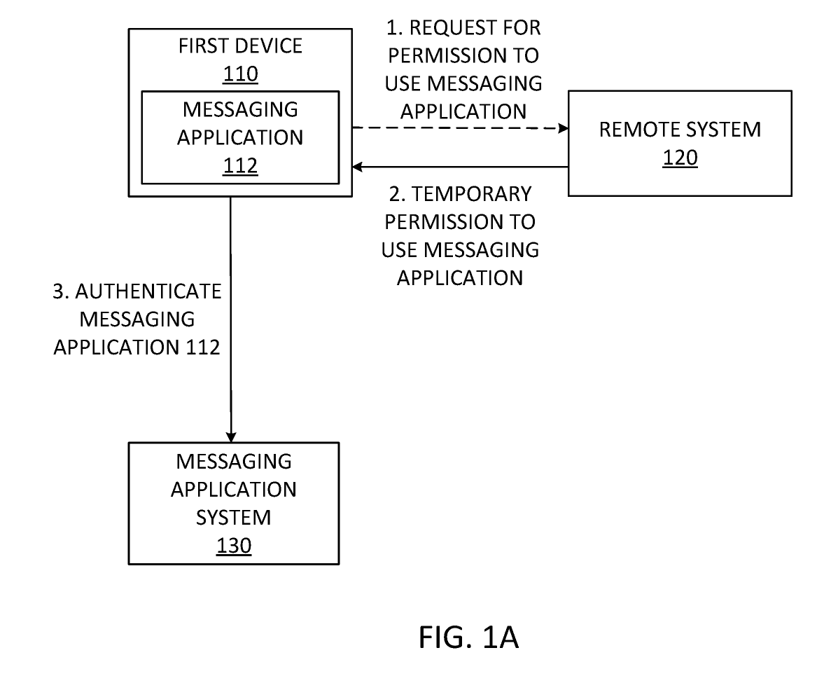

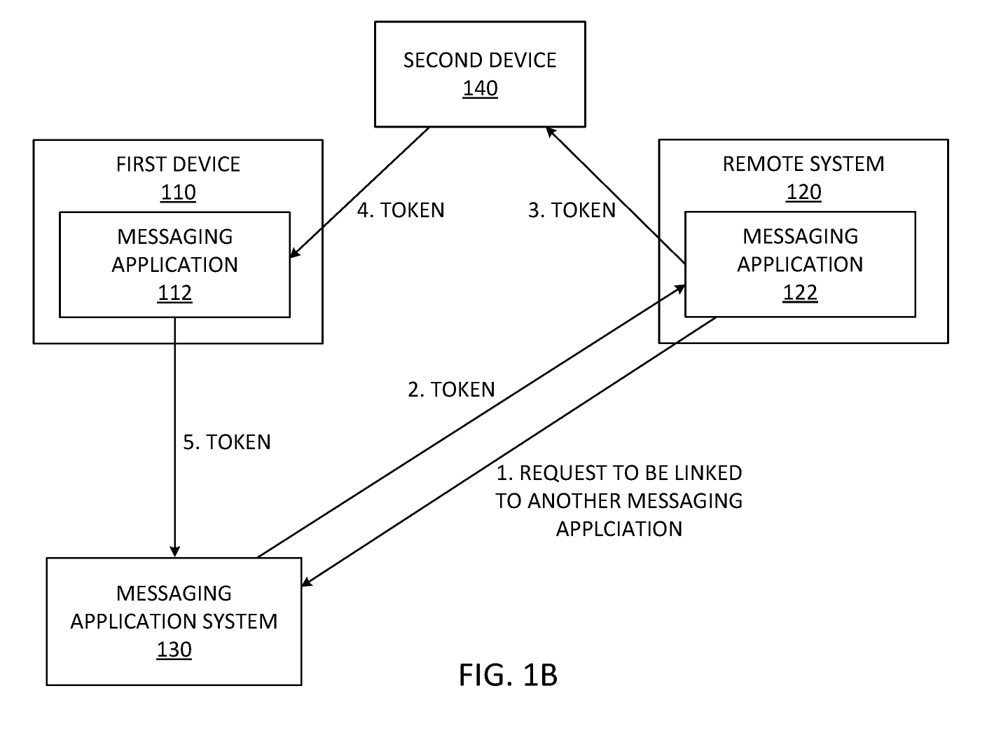

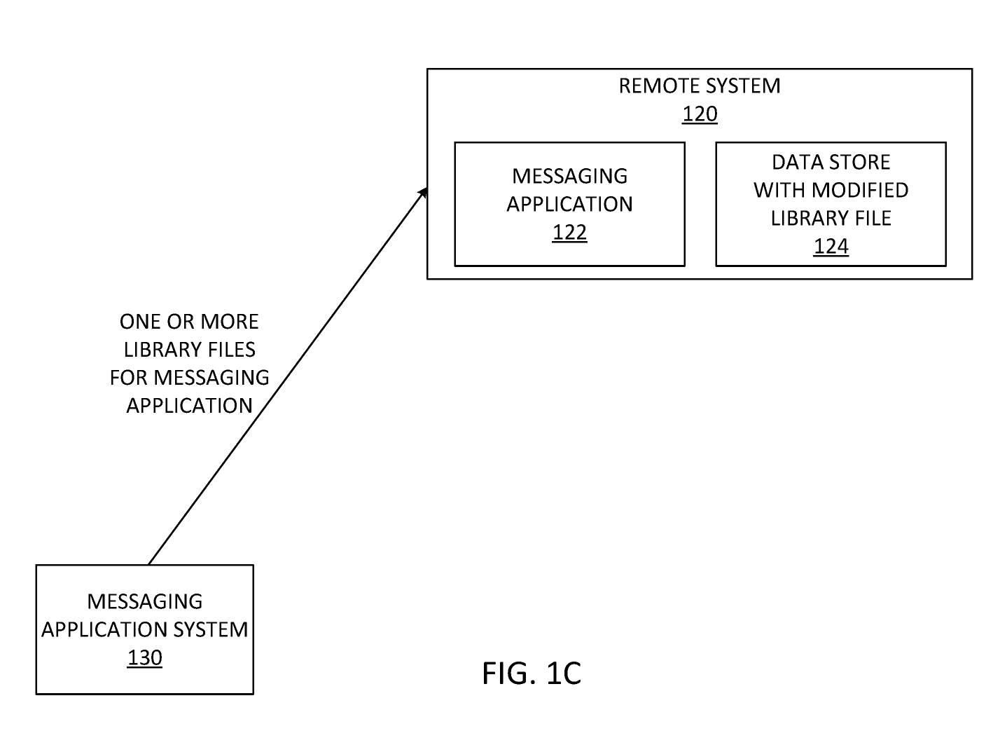

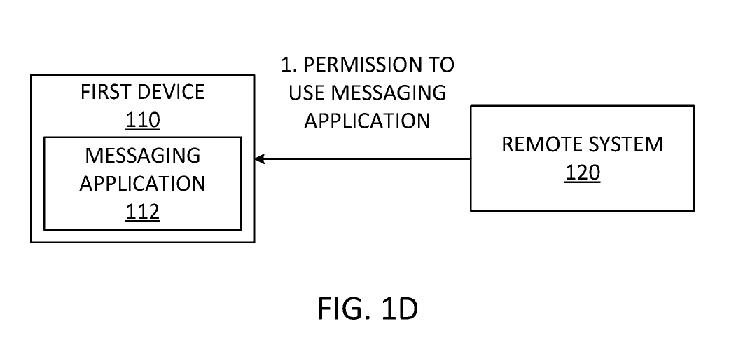

FIGS. 1A-1D illustrate an example for configuring a distributed system for message capture using a first type of authentication according to certain embodiments described herein. The first type of authentication is based upon a remote system using an authentication of a messaging application on a first device to authenticate a messaging application on the remote system. An example of such a messaging application system is WeChat; however, it should be recognized that other messaging application systems use a similar type of authentication. As used herein, authenticating with a messaging application system may include authenticating a messaging application for an account of the messaging application system such that communications sent to the account are sent to the messaging application.

FIG. 1A illustrates a process to allow first device 110 to authenticate messaging application 112 with messaging application system 130 according to certain embodiments described herein. In the process depicted in FIG. 1A, first device 110 is executing messaging application 112. First device 110 may be a mobile phone, laptop, desktop computer, server, or other type of computing device. Messaging application 112 may be a web application, a device application, or other type of code executing on first device 110.

In some examples, to begin the authentication process, first device 110 may receive a message (e.g., an email, an internet communication, an instant message, a short message service (SMS), or the like) from remote system 120 (not illustrated). Remote system 120 may be associated with an enterprise that is tasked with managing first device 110. For example, the enterprise may be a company that issued first device 110 to an employee of the company.

The message may indicate that a user operating first device 110 must follow certain procedures to stay in compliance with remote system 120. For example, a procedure may include ensuring that messages sent or received by a messaging application of first device 110 are sent to remote system 120. In some examples, the message may be sent to first device 110 when first device 110 connects with (e.g., logs into) remote system 120. The message may also be sent to first device 110 in response to remote system 120 determining that a user has possession of first device 110.

The message may include a uniform resource identifier (URI) (e.g., a uniform resource locator (URL) or a uniform resource name (URN)) that, when activated, causes first device 110 to send a request to remote system 120, the request for permission to use messaging application 112. It should be recognized that the message may include a different method (other than the URI) for causing first device 110 to send the request to remote system 120 (e.g., an email address, a phone number, an internet protocol (IP) address, or the like). It should also be recognized that sending the request may cause first device 110 to be logged into remote system 120. In such cases, the URI may be encoded with an identification of a user such that when the URI is activated, remote system 120 receives an identification of first device 110 that serves as a log in to remote system 120. In examples where the request does not automatically include identification information of first device 110, additional information may be added to the request by a user to identify first device 110.

In response to the request, remote system 120 may grant temporary permission for first device 210 to use messaging application 112. In some examples, granting the temporary permission may include remote system 120 sending a communication to an application manager included with first device 110. The communication may cause the application manager to allow first device 110 to use messaging application 112.

It should be recognized that the request does not need to be sent to remote system 120 to request the temporary permission and/or a communication does not need to be sent to first device 110 to grant temporary permission. For example, remote system 120 may automatically grant temporary permission to devices for a particular amount of time or until a particular event occurs. In addition, granting the temporary permission may cause remote system 120 to not send a communication to the application manager to cause first device 210 to disable messaging application 112.

Once first device 110 has been granted temporary permission to use messaging application 112 (or messaging application 112 has not been disabled), first device 110 may authenticate messaging application 112 for the account with messaging application system 130. By authenticating messaging application 112, messaging application 112 may send messages to and receive messages from messaging applications on other devices through messaging application system 130. It should be recognized that authenticating messaging application 112 for the account may vary between different messaging application systems. For example, the authentication process may include messaging application 112 providing a username and/or password associated with the account to messaging application system 130.

Messaging application system 130 may facilitate communication of messages between messaging applications. Messaging application system 130 may be for BlackBerry Messenger, Facebook Messenger, Google Hangouts, KakaoTalk, LINE, WeChat, WhatsApp, or the like. In some examples, messaging application system 130 may be cross platform, such that messaging application system 130 facilitates communications to be sent to multiple types of devices, such as mobile devices, desktop computers, gaming consoles, or the like. For example, messaging application system 130 may receive communications from a mobile device to send to a desktop computer.

FIG. 1B illustrates a process for authenticating messaging application 122 of remote system 120 with messaging application system 130 based upon an authentication of messaging application 112 of first device 110 according to certain embodiments described herein. The process illustrated in FIG. 1B may occur after the process illustrated in FIG. 1A.

In the process depicted in FIG. 1B, messaging application 122 may be the same type of messaging application or a different type of messaging application as messaging application 112. For example, messaging application 112 may be a mobile-based messaging application and messaging application 122 may be a browser-based messaging application. In some examples, messaging application 122 may be executing on a headless browser (e.g., a web browser without a graphical user interface, executing via a command-line interface or using network communication). Examples of headless browsers include PhantomJS, HtmlUnit, TrifleJS, and Splash. In some examples, the headless browser may be a mode for a web browser. For example, web browsers such as Google Chrome and Firefox provide a headless mode. By using a headless browser, fewer resources may be spent to maintain a messaging application because a graphical user interface does not need to be maintained. And by requiring fewer resources, more instances associated with different devices may be executing on a single system.

The process illustrated in FIG. 1B may begin when messaging application 122 sends a request to messaging application system 130. The request may be related to linking messaging application 122 of remote system 120 with another messaging application. Linking a first messaging application with a second messaging application may cause each messaging application to receive messages sent and received by the other messaging application.

In response to the request, messaging application system 130 may send a token to messaging application 122 of remote system 120. While referred to as a token herein, it should be recognized that the token may be referred to as an authentication credential. For explanatory purposes, the token may be a quick response (QR) code. However, it should be recognized that the token may be any form of data that may be uniquely identified. For example, the token may identify the account, first device 110, messaging application 112, messaging application 122, remote system 120, the current authentication process, or the like, or any combination thereof.

Depending on the type of token, messaging application 122 (or remote system 120) may send the token to either first device 110 (or messaging application 112) (not illustrated) or second device 140. The token may be sent to first device 110 (or messaging application 112) when the token does not need to be output by a device before being received by messaging application 112 of first device 110. The token may be sent to second device 140 when the token needs to be output by a device before being received by messaging application 112 of first device 110. For example, a QR code must be presented by a device for another device to scan. In the example depicted in FIG. 1B, the token may be a QR code such that the QR code may be sent from messaging application system 130 to remote system 120 and then to second device 140. Second device 140 may then present the QR code so that first device 110 may scan the QR code. When the token is a QR code, the QR code may encode a uniform resource identifier (URI) (e.g., uniform resource locator (URL) or uniform resource name (URN)). When the QR code encodes a URI, first device 110 may navigate to a destination represented by URI when the QR code is scanned. The destination may cause a communication to be sent to messaging application system 130 indicating that messaging application 122 of remote system 120 should be authenticated. It should be recognized that messaging application 122 may be authenticated using the authentication of messaging application 112 in other ways than described above.

When first device 110 receives the token (e.g., by scanning the QR code), the token may be communicated to messaging application 112 so that messaging application 112 may send the token back to messaging application system 130. By receiving the token from messaging application 112 (which should already be authenticated with messaging application system 130 for the account), messaging application system 130 may authenticate messaging application 122 of remote system 120 for the account based upon receiving the token from an authenticated source.

FIG. 1C illustrates a process for providing a modified library file to be used to execute messaging application 122 on remote system 120 according to certain embodiments described herein. The process illustrated in FIG. 1C may occur after the process illustrated in FIG. 1B (e.g., messaging application 122 may be authenticated with messaging application system 130 for an account); however, it should be recognized that the process illustrated in FIG. 1C may occur before the processing illustrated in FIG. 1B.

The process illustrated in FIG. 1C may begin when messaging application system 130 sends one or more library files to remote system 120. The one or more library files may be used to execute portions of messaging application 122.

Based upon receiving the one or more library files, remote system 120 may identify a modified library file in data store 124. In some examples, remote system 120 may replace a library file in the one or more library files with the modified library file, the library file corresponding to the modified library file. In other examples, remote system 120 may add the modified library file to the one or more library files. In other examples, the modified library file may relate to a separate process that is configured to execute along with messaging application 122 to perform the operations described herein. When the modified library file is a separate process, the separate process may perform the operations described herein rather than messaging application 122. When a separate process, the separate process may capture content displayed by messaging application 122.

FIG. 1D illustrates a process for providing permission for first device 110 to use messaging application 112 according to certain embodiments described herein. The process illustrated in FIG. 1D may occur after the process illustrated in FIG. 1C.

The processing illustrated in FIG. 1D may begin after remote system 120 determines that a communication channel has been established between messaging application 122 and remote system 120 while messaging application 122 is executing based upon a modified library file, as described above. In particular, remote system 120 may grant permission for first device 110 to use (or continue to use) messaging application 112. The permission granted after the communication channel has been established may be different than the temporary permission granted in FIG. 1A. In particular, the permission may be revocable when remote system 120 determines that the communication channel is inactive. Remote system 120 may determine that the communication channel is inactive when data is no longer being received from messaging application system 130.

In some examples, granting the permission may include remote system 120 sending a communication to the application manager included with first device 110. The communication may cause the application manager to allow first device 110 to use messaging application 112.

In other examples, granting the permission may not include an actual communication sent to first device 110. Instead, granting the permission may cause remote system 120 to not send a communication to the application manager to cause first device 110 to disable messaging application 112. Remote system 120 may then send a communication to the application manager to cause first device 110 to disable messaging application 112 when remote system 120 determines that the communication channel is inactive.

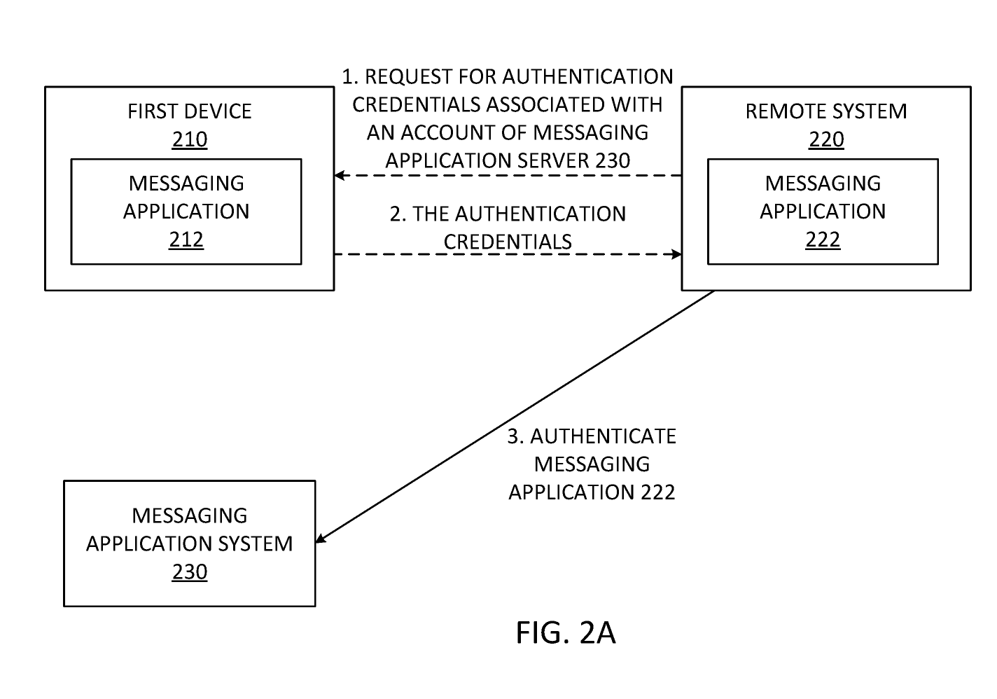

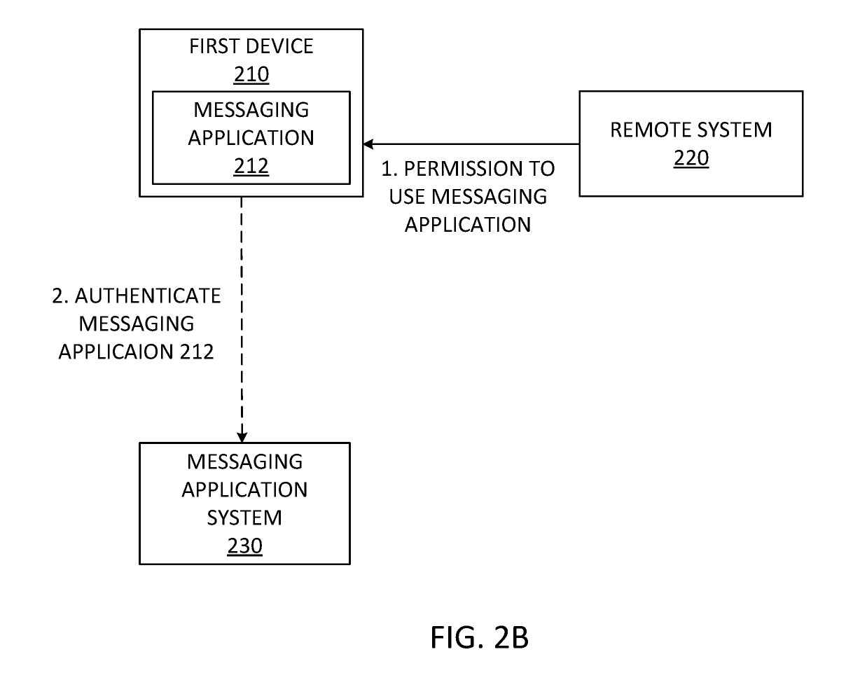

FIGS. 2A and 2B illustrate an example for configuring a distributed system for message capture using a second type of authentication according to certain embodiments described herein. The second type of authentication is based upon each of a first device and a remote system separately authenticating respective messaging applications with a messaging application system for the same account. An example of such a system is Facebook Messenger; however, it should be recognized that other systems use a similar type of authentication.

FIG. 2A illustrates a process for authenticating messaging application 222 with messaging application system 230 according to certain embodiments described herein. In FIG. 2A, messaging application 222 is illustrated as being hosted by remote system 220.

The process illustrated in FIG. 2A may begin when first device 210 receive a message (e.g., an email, an internet communication, an instant message, a short message service (SMS), or the like) from remote system 120 (not illustrated). Remote system 220 may be associated with an enterprise that is tasked with managing first device 210. For example, the enterprise may be a company that issued first device 210 to an employee of the company.

The message may indicate that a user operating first device 210 must follow certain procedures to stay in compliance with remote system 220. In some examples, the message may be sent to first device 210 when first device 210 connects with (e.g., logs into) remote system 220. The message may also be sent to first device 210 in response to remote system 220 determining that a user has possession of first device 210.

The message may include a uniform resource identifier (URI) (e.g., a uniform resource locator (URL) or a uniform resource name (URN)) that, when activated, causes first device 210 to send a request to remote system 220, the request for permission to use messaging application 212. It should be recognized that the message may include a different method (other than the URI) for causing first device 210 to send the request to remote system 220 (e.g., an email address, a phone number, an internet protocol (IP) address, or the like). It should also be recognized that sending the request may cause first device 210 to be logged into remote system 220. In such cases, the URI may be encoded with an identification of a user such that when the URI is activated, remote system 220 receives an identification of first device 210 that serves as a log in to remote system 220. In examples where the request does not automatically include identification information of first device 210, additional information may be added to the request by a user to identify first device 210.

In response to receiving the request for permission to use messaging application 212, remote system 220 may send a request for one or more authentication credentials to first device 210. The one or more authentication credentials may be for an account of messaging application system 230. In one illustrative example, the one or more authentication credentials may include a username and password for the account; however, it should be recognized the one or more authentication credentials may be any type of data that may be used to authenticate a messaging application for an account with a messaging application system.

In response to receiving the one or more authentication credentials (or at some point after the one or more authentication credentials are received), remote system 220 may authenticate messaging application 222 with messaging application system 230 using the one or more authentication credentials. For example, remote system 220 may send a request to messaging application system 230. The request may include the one or more authentication credentials. Messaging application system 230 may confirm whether the one or more authentication credentials are correct to determine whether to authenticate messaging application 222.

FIG. 2B illustrates a process for authenticating messaging application 212 with messaging application system 230 according to certain embodiments described herein. The process illustrated in FIG. 2B may occur before or after the process illustrated in FIG. 2A.

The process illustrated in FIG. 2B may begin when remote system 220 provides first device 210 permission to use messaging application 212. In some examples, the permission may be provided as a communication that causes an application manager on first device 210 to enable or allow messaging application 212 to function. In other examples, the permission may be provided as remote system 220 not sending a communication that causes an application manager on first device 210 to disable messaging application 212. At some point after permission is provided to first device 210, first device 210 may authenticate messaging application 212 with messaging application system 230 using one or more authentication credentials, such as the one or more authentication credentials described above in FIG. 2A. For example, first device 210 may send a request to messaging application system 230. The request may include the one or more authentication credentials. Messaging application system 230 may confirm whether the one or more authentication credentials are correct to determine whether to authenticate messaging application 212.

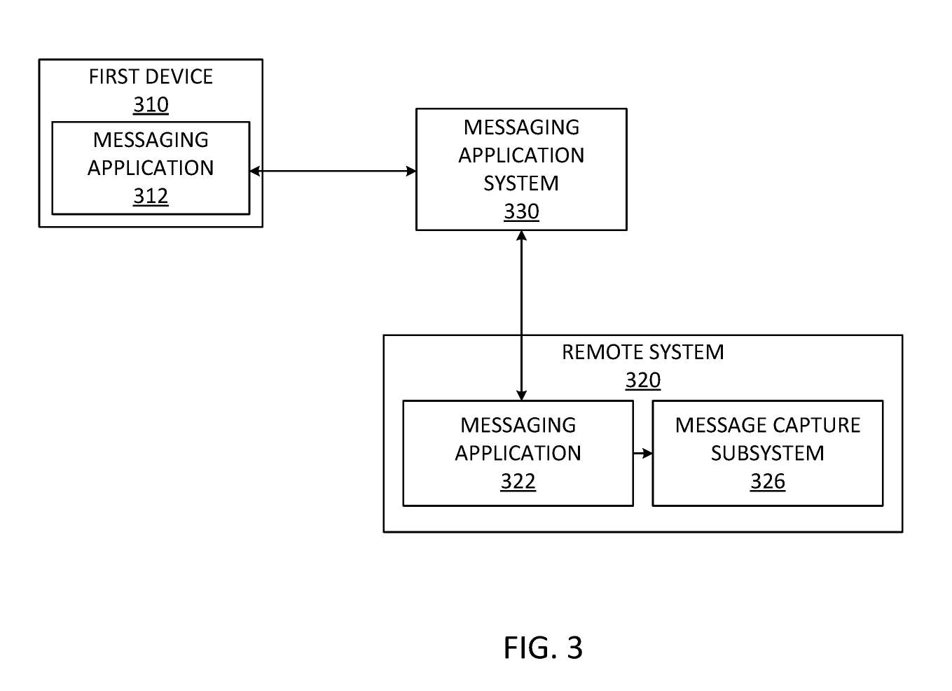

FIG. 3 illustrates an example of communication of a message in a distributed system according to certain embodiments described herein. The example illustrated in FIG. 3 may occur after the process depicted in FIGS. 1A-1D or FIGS. 2A-2B. In particular, the communication of the message may occur after messaging application 312 and messaging application 322 are authenticated for the same account of messaging application system 330. In the distributed system, messaging application 312 may be hosted by and executing on first device 310 and messaging application 322 may be hosted by and executing on remote system 320.

The message may be first communicated to messaging application system 330. In some examples, either messaging application 312 or messaging application 322 may have sent the message to messaging application system 330. In other examples, a messaging application associated with a different account of messaging application system 330 may have sent the message to messaging application system 330. The different account may be in relation the account that messaging application 312 and messaging application 322 are authenticated using.

In response to receipt of the message, messaging application system 330 may send the message to messaging application 312 and/or messaging application 322 (the message will not be sent to a messaging application that originally sent the message).

When messaging application 322 either sends the message or receives the message (depending upon which messaging application originally sent the message), messaging application 322 may execute an operation included in a modified library file. The operation may cause messaging application 322 to send a communication to message capture subsystem 326 of remote system 320 in response to the message being sent or received by messaging application 322. The communication may include information associated with the message. For example, the communication may include the message. In such an example, the message included in the communication may be in a readable format (e.g., unencrypted) due to the message being identified after messaging application 322 prepares the message for presentation by messaging application 322.

Message capture subsystem 326 may be configured to receive messages from messaging applications. Message capture subsystem 326 may store the messages such that the messages may be output (e.g., presented in a graphical user interface or sent to another system to perform one or more operations on the messages, such as analysis).

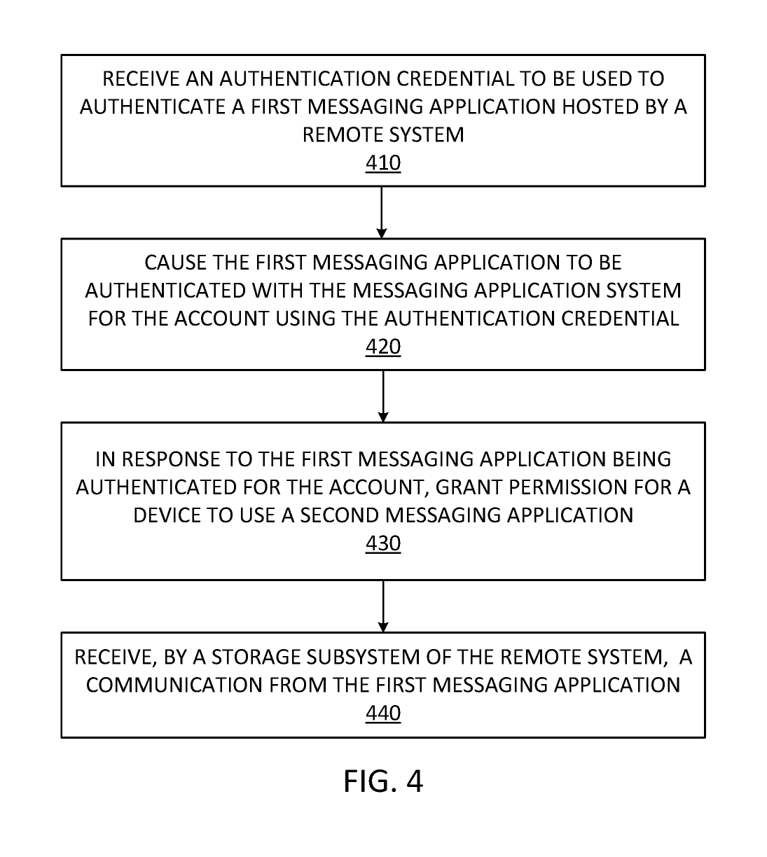

FIG. 4 is a simplified flowchart depicting processing performed for sending a modified library file to a device according to certain embodiments described herein. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain embodiments, the steps may be performed in some different order or some steps may also be performed in parallel.

In the embodiment depicted in FIG. 4, the processing may be triggered at 410 when an authentication credential is received by a remote system for an account of a messaging application system. The authentication credential may be to authenticate a first messaging application hosted by the remote system. In some examples, the authentication credential may be communicated from the remote system to the messaging application system to authenticate the first messaging application. In such examples, the authentication credential may be a password for an account of the messaging application system. The password may be received from a user device. In other examples, the authentication credential may be a token received from a messaging application system. An example of such a token is a quick response (QR) code.

At 420, the remote system may cause the first messaging application to be authenticated with the messaging application system for the account using the authentication credential. When the authentication credential is received from a user device, the remote system may send the authentication credential to the messaging application system. When the authentication credential is received from the messaging application system, the remote system may send the authentication credential to a device. The device may be associated with a user (referred to as a user device) or in proximity to such a user device (referred to as a presentation device). In either case, the user device may be executing a second messaging application that is already authenticated with the messaging application system for the account.

When the authentication credential is sent to the user device, the user device may then send the authentication credential to the messaging application system. By the user device sending the authentication credential, the messaging application system may authenticate the first messaging application based upon the authentication of the user device.

When the authentication credential is sent to the presentation device, the presentation device may display the authentication credential so that the user device may receive the authentication credential. For example, when the authentication credential is a password, a user associated with the user device may enter the password into the user device in response to viewing the password on the presentation device. For another example, when the authentication credential is a QR code, the user device may scan the QR code to receive the authentication credential. After the user device receives the authentication credential, the user device may then send the authentication credential to the messaging application system as described above.

At 430, in response to the first messaging application being authenticated for the account, the remote system may grant permission for a device associated with the user to use a second messaging application. Granting permission may include the remote system sending a communication to the device to cause an application manager on the device to unlock or enable the second messaging application. However, granting permission may include the remote system not sending a communication to the device to cause the second messaging application to be disabled. When the second messaging application is authenticated for the same account as the first messaging application, messages sent and/or received by the second messaging application are sent to the first messaging application.

At 440, a storage subsystem of the remote system may receive a communication from the first messaging application. The communication may be associated with a message sent to or received by the second messaging application, where the communication (or a copy of the communication) is also sent to the storage subsystem in response to the message being received by the first messaging application. In some examples, the first messaging application is executing based upon one or more libraries associated with the messaging application system. In such examples, a library of the one or more libraries may be modified relative to a version of the library that was received from the messaging application system. The modified library may cause the communication to be sent to the storage subsystem. In some examples, the first messaging application may be executing in a headless browser. In such examples, the headless browser may be executing in the remote system.

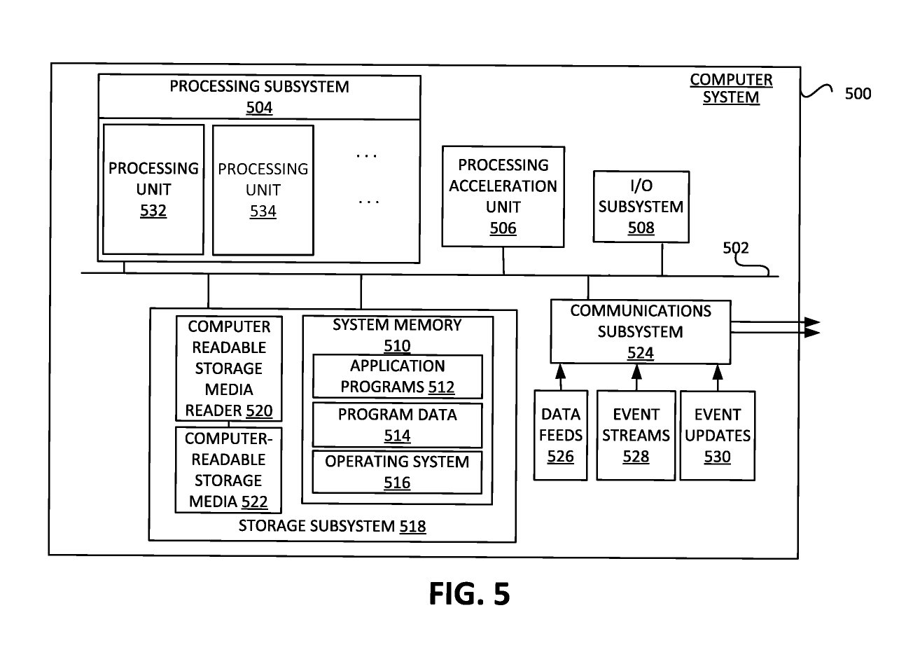

FIG. 5 illustrates an example of computer system 500, which may be used to implement certain embodiments described herein. For example, in some embodiments, computer system 500 may be used to implement any of the systems, servers, devices, or the like described above. As shown in FIG. 5, computer system 500 includes processing subsystem 504, which communicates with a number of other subsystems via bus subsystem 502. These other subsystems may include processing acceleration unit 506, I/O subsystem 508, storage subsystem 518, and communications subsystem 524. Storage subsystem 518 may include non-transitory computer-readable storage media including storage media 522 and system memory 510.

Bus subsystem 502 provides a mechanism for allowing the various components and subsystems of computer system 500 to communicate with each other. Although bus subsystem 502 is shown schematically as a single bus, alternative embodiments of bus subsystem 502 may utilize multiple buses. Bus subsystem 502 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 504 controls the operation of computer system 500 and may comprise one or more processors, application specific integrated circuits (ASICs), or field programmable gate arrays (FPGAs). The processors may include single core and/or multicore processors. The processing resources of computer system 500 may be organized into one or more processing units 532, 534, etc. A processing unit may include one or more processors, one or more cores from the same or different processors, a combination of cores and processors, or other combinations of cores and processors. In some embodiments, processing subsystem 504 may include one or more special purpose co-processors such as graphics processors, digital signal processors (DSPs), or the like. In some embodiments, some or all of the processing units of processing subsystem 504 may be implemented using customized circuits, such as application specific integrated circuits (ASICs), or field programmable gate arrays (FPGAs).

In some embodiments, the processing units in processing subsystem 504 may execute instructions stored in system memory 510 or on computer readable storage media 522. In various embodiments, the processing units may execute a variety of programs or code instructions and may maintain multiple concurrently executing programs or processes. At any given time, some or all of the program code to be executed may be resident in system memory 510 and/or on computer-readable storage media 522 including potentially on one or more storage devices. Through suitable programming, processing subsystem 504 may provide various functionalities described above. In instances where computer system 500 is executing one or more virtual machines, one or more processing units may be allocated to each virtual machine.

In certain embodiments, processing acceleration unit 506 may optionally be provided for performing customized processing or for off-loading some of the processing performed by processing subsystem 504 so as to accelerate the overall processing performed by computer system 500.

I/O subsystem 508 may include devices and mechanisms for inputting information to computer system 500 and/or for outputting information from or via computer system 500. In general, use of the term input device is intended to include all possible types of devices and mechanisms for inputting information to computer system 500. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 500 to a user or other computer system. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 518 provides a repository or data store for storing information and data that is used by computer system 500. Storage subsystem 518 provides a tangible non-transitory computer-readable storage medium for storing the basic programming and data constructs that provide the functionality of some embodiments. Storage subsystem 518 may store software (e.g., programs, code modules, instructions) that, when executed by processing subsystem 504, provides the functionality described above. The software may be executed by one or more processing units of processing subsystem 504. Storage subsystem 518 may also provide a repository for storing data used in accordance with the teachings of this disclosure.

Storage subsystem 518 may include one or more non-transitory memory devices, including volatile and non-volatile memory devices. As shown in FIG. 5, storage subsystem 518 includes system memory 510 and computer-readable storage media 522. System memory 510 may include a number of memories, including (1) a volatile main random access memory (RAM) for storage of instructions and data during program execution and (2) a non-volatile read only memory (ROM) or flash memory in which fixed instructions are stored. In some implementations, a basic input/output system (BIOS), including the basic routines that help to transfer information between elements within computer system 500, such as during start-up, may typically be stored in the ROM. The RAM typically includes data and/or program modules that are presently being operated and executed by processing subsystem 504. In some implementations, system memory 510 may include multiple different types of memory, such as static random access memory (SRAM), dynamic random access memory (DRAM), and the like.

By way of example, and not limitation, as depicted in FIG. 5, system memory 510 may load application programs 512 that are being executed, which may include various applications such as Web browsers, mid-tier applications, relational database management systems (RDBMS), etc., program data 514, and operating system 516.

Computer-readable storage media 522 may store programming and data constructs that provide the functionality of some embodiments. Computer-readable media 522 may provide storage of computer-readable instructions, data structures, program modules, and other data for computer system 500. Software (programs, code modules, instructions) that, when executed by processing subsystem 504 provides the functionality described above, may be stored in storage subsystem 518. By way of example, computer-readable storage media 522 may include non-volatile memory such as a hard disk drive, a magnetic disk drive, an optical disk drive such as a CD ROM, DVD, a Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 518 may also include computer-readable storage media reader 520 that may further be connected to computer-readable storage media 522. Reader 520 may receive and be configured to read data from a memory device such as a disk, a flash drive, etc.

In certain embodiments, computer system 500 may support virtualization technologies, including but not limited to virtualization of processing and memory resources. For example, computer system 500 may provide support for executing one or more virtual machines. In certain embodiments, computer system 500 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 500. Accordingly, multiple operating systems may potentially be run concurrently by computer system 500.

Communications subsystem 524 provides an interface to other computer systems and networks. Communications subsystem 524 serves as an interface for receiving data from and transmitting data to other systems from computer system 500. For example, communications subsystem 524 may enable computer system 500 to establish a communication channel to one or more client devices via the Internet for receiving and sending information from and to the client devices.

Communication subsystem 524 may support both wired and/or wireless communication protocols. For example, in certain embodiments, communications subsystem 524 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 524 may provide wired network connectivity (e.g., Ethernet) in addition to or instead of a wireless interface.

Communication subsystem 524 may receive and transmit data in various forms. For example, in some embodiments, in addition to other forms, communications subsystem 524 may receive input communications in the form of structured and/or unstructured data feeds 526, event streams 528, event updates 530, and the like. For example, communications subsystem 524 may be configured to receive (or send) data feeds 526 in real-time from users of social media networks and/or other communication services such as web feeds and/or real-time updates from one or more third party information sources.

In certain embodiments, communications subsystem 524 may be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 524 may also be configured to communicate data from computer system 500 to other computer systems or networks. The data may be communicated in various different forms such as structured and/or unstructured data feeds 526, event streams 528, event updates 530, and the like to one or more databases that may be in communication with one or more streaming data source computers coupled to computer system 500.

Computer system 500 may be one of various types, including a handheld portable device, a wearable device, a personal computer, a workstation, a mainframe, a kiosk, a server rack, or any other data processing system. Due to the ever-changing nature of computers and networks, the description of computer system 500 depicted in FIG. 5 is intended only as a specific example. Many other configurations having more or fewer components than the system depicted in FIG. 5 are possible. Based on the disclosure and teachings provided herein, a person of ordinary skill in the art will appreciate other ways and/or methods to implement the various embodiments.

The processes described herein are each illustrated in a particular order, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a machine-readable storage medium, for example, in the form of a computer program comprising a plurality of instructions executable by one or more processors. The machine-readable storage medium can be non-transitory.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

A number of embodiments of the invention have been described. Nevertheless, it will be understood that various modification may be made without departing from the scope of the invention.

What is claimed is:

1. A method comprising:
receiving, by a remote system, an authentication credential to be used to authenticate a first messaging application hosted by the remote system, wherein the authentication is for an account with a messaging application system;
causing, by the remote system, the first messaging application to be authenticated with the messaging application system for the account using the authentication credential;
in response to the first messaging application being authenticated for the account, granting, by the remote system, permission for a device to use a second messaging application, wherein messages sent and received by the second messaging application are sent to the first messaging application when the second messaging application is authenticated for the same account as the first messaging application; and
receiving, by a storage subsystem of the remote system, a communication from the first messaging application, wherein the communication is associated with a message sent to or received by the second messaging application, and wherein the communication is sent to the storage subsystem in response to the message being received by the first messaging application.

2. The method of claim 1, wherein the first messaging application is executing based upon one or more libraries associated with the messaging application system, wherein a library of the one or more libraries is modified relative to a version of the library that was received from the messaging application system, and wherein the modified library causes the communication to be sent to the storage subsystem.

3. The method of claim 1, wherein the authentication credential is received from the device.

4. The method of claim 1, wherein the authentication credential is received from the messaging application system.

5. The method of claim 4, wherein the device with the second messaging application is a first device, wherein causing the first messaging application to be authenticated with the messaging application system for the account includes:
sending the authentication credential to a second device, wherein the second device sends the authentication credential to the first device.

6. The method of claim 5, wherein the authentication credential is a quick response (QR) code, and wherein the QR code is presented by the second device for the first device to scan.

7. The method of claim 1, further comprising:
sending, by the remote system, a communication to the device, wherein the communication includes a uniform resource identifier (URI) associated with the remote system, and wherein activation of the URI causes the remote system to authenticate the first messaging application.

8. The method of claim 1, wherein the first messaging application is executing on the remote system.

9. The method of claim 1, wherein the first messaging application is executing in a headless browser.

10. A non-transitory computer-readable storage medium storing a plurality of instructions executable by one or more processors, the plurality of instructions when executed by the one or more processors cause the one or more processors to:
receive an authentication credential to be used to authenticate an account of a messaging application system;
cause a first messaging application to be authenticated with the messaging application system for the account using the authentication credential;
in response to the first messaging application being authenticated for the account, grant permission for a device to use a second messaging application with the account, wherein messages sent and received by the second messaging application are sent to the first messaging application when the second messaging application is logged into the same account as the first messaging application; and
receive by a storage subsystem, a communication from the first messaging application, wherein the communication is associated with a message sent to or received by the second messaging application, and wherein the communication is sent to the storage subsystem in response to the message being received by the first messaging application.

11. The non-transitory computer-readable storage medium of claim 10, wherein the first messaging application is executing based upon one or more libraries associated with the messaging application system, wherein a library of the one or more libraries is modified relative to a version of the library that was received from the messaging application system, and wherein the modified library causes the communication to be sent to the storage subsystem.

12. The non-transitory computer-readable storage medium of claim 10, wherein the authentication credential is a password provided by a user.

13. The non-transitory computer-readable storage medium of claim 10, wherein the authentication credential is a token provided by the messaging application system.

14. The non-transitory computer-readable storage medium of claim 13, wherein the device with the second messaging application is a first device, wherein causing the first messaging application to be authenticated with the messaging application system for the account includes:
sending the token to a second device, wherein the second device sends the token to the first device.

15. The non-transitory computer-readable storage medium of claim 14, wherein the token is a quick response (QR) code, wherein the QR code is presented by the second device for the first device to scan.

16. The non-transitory computer-readable storage medium of claim 10, further comprising:
sending, by the remote system, a communication to the device, wherein the communication includes a uniform resource identifier (URI) associated with the remote system, and wherein activation of the URI causes the remote system to authenticate the first messaging application.

17. The non-transitory computer-readable storage medium of claim 10, wherein the first messaging application is executing on the one or more processors.

18. A system for granting a first device permission to use a first messaging application, the system comprising:
one or more processors; and
a non-transitory computer-readable medium including instructions that, when executed by the one or more processors, cause the one or more processors to:
receive an authentication credential to be used to authenticate an account of a messaging application system;
cause a first messaging application to be authenticated with the messaging application system for the account using the authentication credential;
in response to the first messaging application being authenticated for the account, grant permission for a device to use a second messaging application with the account, wherein messages sent and received by the second messaging application are sent to the first messaging application when the second messaging application is logged into the same account as the first messaging application; and
receive, by a storage subsystem of the system, a communication from the first messaging application, wherein the communication is associated with a message sent to or received by the second messaging application, and wherein the communication is sent to the storage subsystem in response to the message being received by the first messaging application.

19. The system of claim 18, wherein the first messaging application is executing based upon one or more libraries associated with the messaging application system, wherein a library of the one or more libraries is modified relative to a version of the library that was received from the messaging application system, and wherein the modified library causes the communication to be sent to the storage subsystem.

20. The system of claim 18, further comprising:
send a communication to the first device, wherein the communication includes a uniform resource identifier (URI) associated with the system, and wherein activation of the URI causes the system to authenticate the first messaging application.
